(19) United States
(12) Patent Application Publication
(10) Pub. No.: US 2010/0046879 A1
(43) Pub. Date: Feb. 25, 2010

(54) Optical Modulator

(75) Inventors: Michael G. Lee, San Jose, CA (US); Alexei L. Glebov, San Mateo, CA (US); Dashun Steve Zhou, San Jose, CA (US)

Correspondence Address: BAKER BOTTS L.L.P., 2001 ROSS AVENUE, SUITE 600, DALLAS, TX, 75201-2980, US

(73) Assignee: Fujitsu Limited, Kawasaki-shi (JP)

(21) Appl. No.: 12/197,658

(22) Filed: Aug. 25, 2008

(51) Int. Cl. G02F 1/225

(52) U.S. Cl. 385/2

(57) ABSTRACT

An optical modulator includes an input waveguide, a splitting point, a first interaction arm of length L₁, a second interaction arm of length L₂ that is unequal in length to the first interaction arm, a recombination point, and an output waveguide. The splitting point receives an incoming continuous wave light beam comprising two or more wavelengths of light from the input waveguide and splits it into a first light beam and a second light beam. The first interaction arm is coupled to the input waveguide and transports the first light beam. The second interaction arm is coupled to the input waveguide and transports the second light beam. The output waveguide is coupled to the first interaction arm and second interaction arm at the recombination point and combines the first light beam and second light beam into an output modulated light beam. The first interaction arm and the second interaction arm comprise an electro-optic material with a refractive index that changes according to a modulation stimulus. The electro-optic material has a first refractive index n₁ before the modulation stimulus is applied, and a second refractive index n₂ after the modulation stimulus is applied.

### TECHNICAL FIELD

This disclosure relates in general to optics and more particularly to an optical modulator.

### BACKGROUND

Optical communications systems typically include a light producing device such as a laser, a transmission medium such as an optical fiber, and a device to receive and interpret the light transmitted by the laser.

Modulation of data to be transmitted onto optical signals is an essential function in all optical communications systems. For low speed communications, modulation typically involves modulating the current to the transmission laser, i.e. turning the laser on and off to produce the patterns of light that correspond to the data to be transmitted. For high speed communications, however, external modulators are needed to modulate the transmitted light. A common modulator used in high-speed optical communications systems is the Mach-Zehnder modulator.

The Mach-Zehnder modulator is a device that splits an incoming light beam into two separate beams and channels each beam through an “interaction arm” for a short distance. The arms of a Mach-Zehnder modulator are equal in length and are constructed of an electro-optic material whose refractive index changes when an electric field is applied. A change in the refractive index of the arms affects the light passing through almost instantaneously—an increase in refractive index slows down the light while a decrease allows the light to travel faster.

After passing through their respective interaction arms, the beams are recombined back into a single beam at a recombination point. When the beams are recombined, the intensity of the resulting beam depends on the refractive index of the arms that the two individual beams traveled through. If no voltage was applied to either arm, the refractive index of the arms remains the same and the two beams constructively interfere when recombined. The resulting beam will be almost equal to the intensity of the original beam that entered the Mach-Zehnder modulator. However, a voltage may be applied to one of the arms in order to change its refractive index and thus cause the beam passing through it to be 180 degrees out of phase from the other beam. When recombined, these two beams will destructively interfere and effectively cancel each other out. Thus, no beam of light will exit the Mach-Zehnder modulator. In this way, the light beam may be turned on an off, i.e. modulated, by simply applying and removing a voltage to one of the interaction arms.

### SUMMARY OF THE DISCLOSURE

The present disclosure provides an optical modulator that substantially eliminates or reduces at least some of the disadvantages and problems associated with previous methods and systems.

According to one embodiment, an optical modulator includes an input waveguide, a splitting point, a first interaction arm of length L₁, a second interaction arm of length L₂ that is unequal in length to the first interaction arm, a recombination point, and an output waveguide. The splitting point receives an incoming continuous wave light beam comprising two or more wavelengths of light from the input waveguide and splits it into a first light beam and a second light beam. The first interaction arm is coupled to the input waveguide and transports the first light beam. The second interaction arm is coupled to the input waveguide and transports the second light beam. The output waveguide is coupled to the first interaction arm and second interaction arm at the recombination point and combines the first light beam and second light beam into an output modulated light beam. The first interaction arm and the second interaction arm comprise an electro-optic material with a refractive index that changes according to a modulation stimulus. The electro-optic material has a first refractive index n₁ before the modulation stimulus is applied, and a second refractive index n₂ after the modulation stimulus is applied.

Technical advantages of certain embodiments may include providing for the modulation of more than one wavelength of light using a single modulator resulting in robust operation when one light source fails or becomes unstable in light intensity. Other advantages may include a decrease in the number of components required to modulate optical signals on a circuit board and a reduction in the cost of the overall system. Embodiments may eliminate certain inefficiencies such as requiring separate modulators for every wavelength of light on a circuit board.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a simplified block diagram illustrating an example optical communication system in accordance with a particular embodiment;

FIG. 2 is an optical modulator in accordance with a particular embodiment; and

FIG. 3 is an optical signal modulation method in accordance with a particular embodiment.

### DETAILED DESCRIPTION OF THE DISCLOSURE

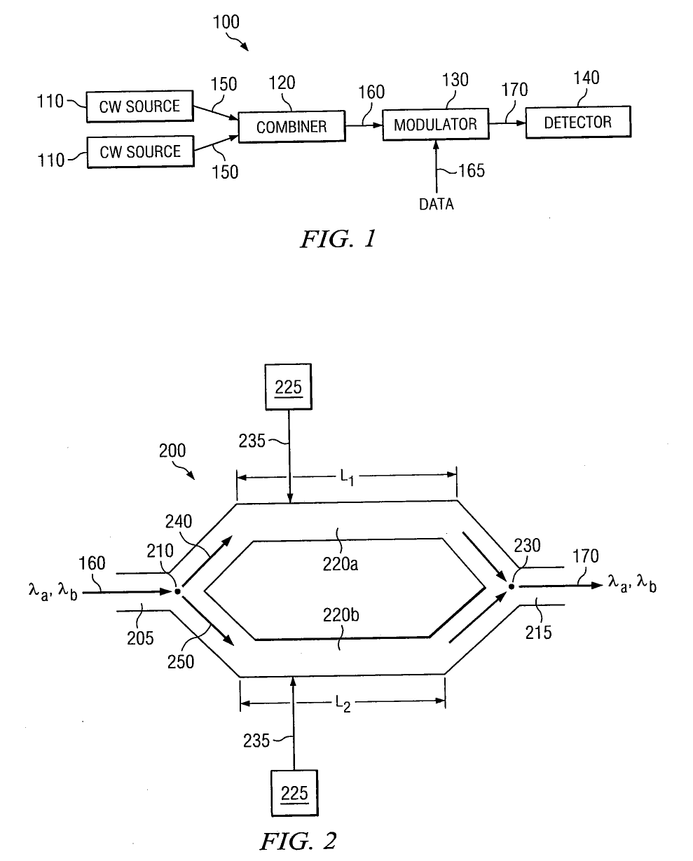

FIG. 1 depicts an example simplified optical communication system 100. Optical communication system 100 includes two or more continuous wave (“CW”) light sources 110, an optical combiner 120, an optical modulator 130, and an optical receiver 140. CW light sources 110 are coupled to combiner 120 and typically consist of lasers or any other device that produces a continuous wave light beam. Combiner 120 is further coupled to modulator 130 which is in turn coupled to optical receiver 140. Devices 110, 120, 130, and 140 are typically coupled by optical waveguides, such as rectangular waveguides, slab waveguides, optical fibers, and the like. It should be noted, however, that one or more of 110, 120, and 130 may be co-located. Also, optical receiver 140 may be some distance from modulator 130, and one or more components (possibly not shown) may be located between modulator 130 and receiver 140.

In operation, each CW light source 110 produces a continuous wave light beam 150 which is transmitted to combiner 120. Each continuous wave light beam 150 consists of a different wavelength of light, λ. Combiner 120 receives the two or more continuous wave beams 150 and combines them into a single multiplexed light beam 160 containing each of the individual wavelengths of light. Combiner 120 may be any suitable optical multiplexing device, such as gratings and filters. Modulator 130 (described in more detail below) receives multiplexed light beam 160 and data 165 and outputs a modulated light beam 170 that is modulated with the data. Modulated light beam 170 is then transmitted to optical receiver 140 where it is received and interpreted.

FIG. 2 depicts an optical modulator 200 in accordance with a particular embodiment which could be utilized as modulator 130, discussed above in connection with FIG. 1. Optical modulator 200 includes an input waveguide 205, a splitting point 210, interaction arms 220a and 220b having different lengths, L₁ and L₂, respectively, a recombination point 230, and an output waveguide 215. Input waveguide 205 is coupled to interaction arms 220a and 220b at splitting point 210, and interaction arms 220a and 220b are coupled to output waveguide 215 at recombination point 230. Interaction arms 220a and 220b are also coupled to a stimulus source 225 and receive a modulation stimulus 235 from stimulus source 225. Optical modulator 200 may be constructed from any material that allows the propagation of light beams and whose refractive index may be manipulated by modulation stimulus 235 such as an electric field and/or heat. Such materials include, but are not limited to, polymer, lithium niobate, and silicon photonics. Optical modulator 200 is similar in design to the well-known Mach-Zehnder modulator, but with key modifications and advantages as will be discussed in detail below.

In operation, multiplexed light beam 160, containing at least two different wavelengths of light (such as λₐ and λ_{b}), enters optical modulator 200 via input waveguide 205 and travels to splitting point 210. At splitting point 210, multiplexed light beam 160 is divided into two light beams: upper light beam 240 and lower light beam 250, each comprising λₐ and λ_{b}. Upper light beam 240 and lower light beam 250 travel through their respective interaction arms 220a and 220b until they arrive at recombination point 230 where they are combined back into a single light beam to form modulated light beam 170.

As mentioned above, optical modulator 200 is constructed of a material whose refractive index may be manipulated by an external modulation stimulus such as an electric field and/or heat. Any change in the refractive index of the material will cause a phase-shift in the light passing through it almost instantaneously. When upper light beam 240 and lower light beam 250 are recombined at recombination point 230, the intensity of resulting modulated light beam 170 is determined by the phase difference between the two light beams 240 and 250. If neither upper light beam 240 or lower light beam 250 has been modified, and thus there is no phase difference between them, the two beams will constructively combine to form modulated light beam 170 that has the same intensity (less the propagation loss) of multiplexed light beam 160. If, however, one of the two beams has been modified to create a phase difference of 180 degrees, the two beams will destructively interfere and effectively cancel each other out. In this way, the intensity of modulated light beam 170 is controlled (i.e. modulated) by adjusting the phase of upper light beam 240, lower light beam 250, or both.

In order to adjust the phase of upper light beam 240 and/or lower light beam 250 to control the intensity of modulated light beam 170, modulation stimulus 235 may be applied to one or both interaction arms 220 to change the refractive index. In some embodiments, this modulation stimulus may be voltage. Alternatively or additionally, a thermal bias may be applied to one or both interaction arms 220. This may be accomplished by a thin film electric heater or the like.

In a traditional Mach-Zehnder modulator having upper and lower arms of equal length and having only a single wavelength of light as an input, the total phase difference, Δφ, between the upper light beam and the lower light beam at the recombination point may be calculated by equation (1) below:

$$Δφ = 2 π Δ n \frac{L}{λ} \qquad ( 1 )$$

where L is the physical length of the interaction arms, n is the refractive index of the modulator, λ is the wavelength of the light beam, and Δn is the change in refractive index. An may result from a modulation stimulus such as voltage or heat being applied to either or both interaction arms according to well-known methods in the art. If a multiplexed light beam containing two wavelengths of light, λₐ and λ_{b}, were to be input, the total phase difference between the upper light beam and the lower light beam at the recombination point may be calculated by equations (2) and (3) below:

$$\begin{matrix}Δ {φ}_{a} = 2 π Δ n \frac{L}{{λ}_{a}} & ( 2 ) \\ Δ {φ}_{b} = 2 π Δ n \frac{L}{{λ}_{b}} & ( 3 )\end{matrix}$$

where Δφₐ is the total phase difference of λₐ, and Δφ_{b} is the total phase difference of λ_{b}. In order to fully attenuate modulated light beam 170, the phase difference between upper light beam 240 and lower light beam 250 at recombination point 230 should be 180 degrees (i.e., π). To accomplish simultaneous full attenuation of both wavelengths λₐ and λ_{b}, equations (2) and (3) above must both equal π, which is not possible since λₐ≠λ_{b}. If Δφ for a λ is even a few degrees from 180 degrees, the attenuation can be significantly impaired.

In order to provide suitable attenuation of two or more wavelengths of light, optical modulator 200 includes interaction arms 220 of unequal lengths, L₁ and L₂. As a consequence, there will be an intrinsic phase difference between upper light beam 240 and lower light beam 250 when no modulation stimulus 235 (such as voltage and/or heat) is applied to interaction arms 220. When modulation stimulus 235 is applied, however, the phase of upper light beam 240, φ₁, and the phase of lower light beam 250, φ₂, may be calculated by equations (4) and (5) below:

$$\begin{matrix}{φ}_{1} = 2 π {n}_{1} \frac{{L}_{1}}{λ} = 2 π {n}_{1} \frac{{L}_{2} + Δ L}{λ} & ( 4 ) \\ {φ}_{2} = 2 π {n}_{2} \frac{{L}_{2}}{λ} = 2 π ( {n}_{1} + Δ n ) \frac{{L}_{2}}{λ} & ( 5 )\end{matrix}$$

where L₁ is the physical length of upper interaction arm 220a, L₂ is the physical length of lower interaction arm 220b, ΔL is the difference in length between L₁ and L₂, and n₁ is the initial refractive index of interaction arms 220 before modulation stimulus 235 is applied. Therefore, the phase difference between upper light beam 240 and lower light beam 250, Δφ, may be calculated by equation (6) below:

$$Δ φ = 2 π Δ n \frac{{L}_{2}}{λ} + 2 π {n}_{1} \frac{Δ L}{λ} = 2 π \frac{{L}_{2} Δ n + {n}_{1} Δ L}{λ} \qquad ( 6 )$$

For full attenuation of modulated light beam 170, the phase difference between upper light beam 240 and lower light beam 250 should be 180 degrees (equation (6) must equal π). In addition, full attenuation also occurs when the phase difference between upper light beam 240 and lower light beam 250 equals 180 degrees plus multiples of 360 degrees (540°, 900°, etc.) according to equation (7) below:

Δφ=(2m−1)π, m=1,2,3 (7)

where m is an integer. Thus, by combining equations (6) and (7), the total phase difference, Δφ, may be found according to equation (8) below:

$$Δ φ = 2 π \frac{{L}_{2} Δ n + {n}_{1} Δ L}{λ} = ( 2 m - 1 ) π \qquad ( 8 )$$

But since multiplexed light beam 160 contains at least two different wavelengths of light, λₐ and λ_{b}, the total phase difference, Δφₐ, of upper light beam 240 and lower light beam 250 having wavelength λₐ, and the total phase difference, Δφ_{b}, of upper light beam 240 and lower light beam 250 having wavelength λ_{b}, may be calculated by equations (9) and (10) below:

$$\begin{matrix}{Δφ}_{a} = 2 π \frac{{L}_{2} Δ n + {n}_{1} Δ L}{{λ}_{a}} = ( 2 {m}_{a} - 1 ) π & ( 9 ) \\ Δ {φ}_{b} = 2 π \frac{{L}_{2} Δ n + {n}_{1} Δ L}{{λ}_{b}} = ( 2 {m}_{b} - 1 ) π & ( 10 )\end{matrix}$$

where mₐ and m_{b} are integers and are not necessarily equal to each other.

In order for both wavelengths λₐ and λ_{b} of multiplexed light beam 160 to be simultaneously attenuated, equations (9) and (10) above may be solved for ΔL such that both equations equal 180 degrees (i.e., π). In such a case, both wavelengths λₐ and λ_{b} of multiplexed light beam 160 will be at full attenuation when modulation stimulus 235 is applied to one or both interaction arms 220. Conversely, when no modulation stimulus 235 is applied, one wavelength (i.e., λ_{b}) of multiplexed light beam 160 will be at full intensity (i.e., no attenuation) due to completely constructive interference, while the other wavelength (i.e., λ_{b}) is at almost full intensity due to slightly destructive interference.

In order to find a ΔL such that both wavelengths λₐ and λ_{b} of multiplexed light beam 160 will be simultaneously attenuated, equations (9) and (10) may be set equal to each other and solved for m_{b} to obtain equation (11) below:

$${m}_{b} = \frac{{λ}_{a}}{Δ λ} Δ m + \frac{1}{2} \qquad ( 11 )$$

where Δλ and Δm are found by the following equations:

Δλ=λₐ−λ_{b} Δm=mₐ−m_{b}

Additionally, ΔL may be derived from equations (9) and (10) according to equation (12) below:

$$Δ L = \frac{1}{{n}_{1}} ( \frac{Δ m}{\frac{1}{{λ}_{a}} - \frac{1}{{λ}_{b}}} + \frac{{λ}_{a}}{2} ) \qquad ( 12 )$$

To determine ΔL such that equations (9) and (10) are simultaneously satisfied, a designer may experiment with Δm integer values and equation (11) above to find a Δm that yields an integer value for m_{b}. For example, a designer may first insert Δm=1 into equation (11). If Δm=1 yields an integer value for m_{b}, then Δm=1 may then be used in equation (12) to find ΔL. Upper interaction arm 220a and lower interaction arm 220b may then be designed such that they have a difference in length of ΔL. If, however, Δm=1 does not yield an integer value for m_{b} in equation (11), Δm may be incremented to Δm=2 and inserted back into equation (11). This process may be repeated until a particular Δm integer value yields an integer value for m_{b} in equation (11).

By having a difference in length of ΔL, interaction arms 220a and 220b provide the simultaneous attenuation of both wavelengths λₐ and λ_{b} of multiplexed light beam 160. This provides a convenient and cost-effective way to implement system redundancy without additional components and cost. Since optical modulator 200 simultaneously modulates more than one wavelength of light, it will produce modulated light beam 170 having λₐ even when the CW light source for λ_{b} fails. As a result, optical receiver 140 will still receive modulated light beam 170 having λₐ from optical modulator 200 despite the failure of one of the CW light sources.

As an example only, common wavelengths of light λₐ and λ_{b} used in optical communications include λₐ=1.53 nm and λ_{b}=1.55 nm. A typical refractive index may be n=1.5 and a typical change in refractive index may be Δn=3.825×10⁻⁵. Using these typical values, a difference in length of ΔL=78.54 um may be implemented to achieve full attenuation for both λₐ=1.53 nm and λ_{b}=1.55 nm when a small modulation stimulus 235 (such as voltage) is applied to one or both interaction arms 220 in order to produce a change in refractive index of Δn=3.825×10⁻⁵. In addition, this difference in length of interaction arms 220 also provides a nearly identical extinction ratio for both wavelengths of light when no modulation stimulus 235 is applied. In this manner, an optical modulator 200 with a difference in length of interaction arms 220 of ΔL=78.54 may be used to provide the simultaneous modulation of multiplexed light beam 160 containing these two wavelengths of light.

If a difference in length of interaction arms 220 of ΔL=78.54 may not be precisely realized, a small bias voltage may also be applied to fine tune the intrinsic phase difference caused by the difference in length of interaction arms 220. This bias voltage may be a small fraction (for example, one tenth) of the magnitude of modulation stimulus 235. This provides additional flexibility in the design and manufacture of optical modulator 200.

This embodiment provides a big advantage over typical Mach-Zehnder modulators. Typically, Mach-Zehnder modulators have a symmetric design (equal interaction arm lengths) and thus may only modulate a single frequency of light. Optical modulator 200, on the other hand, may be utilized to implement system redundancy by accepting and modulating multiplexed light beam 160 containing two or more wavelengths of light from multiple CW light sources 110. If one CW light source 110 fails, signal modulation would not be significantly affected, as would be the case with a typical Mach-Zehnder modulator, since other CW light sources 110 operating on a different wavelength would continue to produce light.

In addition, to accomplish the simultaneous modulation of multiple wavelengths of light with typical Mach-Zehnder modulators, the multiple wavelengths would each need to be sent to individual Mach-Zehnder modulators. This would result in additional components, cost, and circuit board real estate. Using this embodiment, however, a designer my simultaneously modulate multiple wavelengths of light with a single modulator. This results in a substantial component, cost, and real estate savings. Also, since this embodiment may be easily implemented in CAD, there is no need for additional fabrication or processing steps, and there is no need for additional test equipment.

Modifications, additions, or omissions may be made to optical modulator 200 and the described components. As an example, while FIG. 1 depicts two CW light sources 110 and the description of FIG. 2 discloses two wavelengths of light, optical modulator 200 may be modified to simultaneously modulate more than two wavelengths of light. Additionally, while certain embodiments have been described in detail, numerous changes, substitutions, variations, alterations and modifications may be ascertained by those skilled in the art. For example, while FIG. 2 has been described in reference to an optical modulator, certain embodiments may be utilized in a wide range of devices including interferometers and the like. In addition, while specific wavelengths of light have been disclosed, certain embodiments may be modified to simultaneously modulate a wide range of wavelengths. It is intended that the present disclosure encompass all such changes, substitutions, variations, alterations and modifications as falling within the spirit and scope of the appended claims.

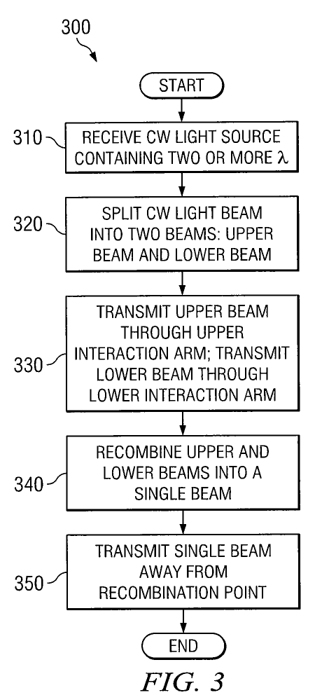

With reference now to FIG. 3, an example optical signal modulation method 300 is provided. Optical signal modulation method 300 may be implemented, for example, by optical modulator 200 described in reference to FIG. 2 above. Optical signal modulation method 300 begins in step 310 where a CW light beam having two or more wavelengths of light λ is received via an input waveguide. In step 320, the CW light beam is split into two light beams: an upper light beam and a lower light beam. Both light beams contain the two or more wavelengths of light λ that were present in the CW light beam received in step 310. After the CW light beam is split into upper and lower light beams, the beams are transmitted through individual interaction arms in step 330. In this step, the upper light beam is transmitted through an upper interaction arm, and the lower beam is transmitted through a lower interaction arm. The upper and lower interaction arms have unequal physical lengths of L₁ and L₂, respectively, as described above in reference to FIG. 2. Also, a modulation stimulus may be applied to one or both interaction arms in order to produce a phase difference in the light beam passing through it. This is accomplished by the fact that the interaction arms are constructed of a material whose refractive index may be adjusted by an external stimulus such as voltage or heat.

In step 340, the upper and lower light beams are recombined back into a combined light beam at a recombination point. In step 350, the combined light beam is transmitted away from the recombination point via an output waveguide. The resulting combined light beam will contain the same two or more wavelengths of light λ that were present in the CW light beam received in step 310. The intensities of the individual wavelengths of light, however, depend on whether any stimulus was applied to the interaction arms in step 330. If no stimulus was applied, the resulting wavelengths of light in the combined light beam will be at or near the same intensity as the CW light beam received in step 310. If, however, a stimulus was applied to one or both of the interaction arms in order to cause a change in refractive index, its beam of light may be 180 degrees out of phase from the other beam. As a result, the resulting wavelength of light in the combined light beam in step 340 will be effectively cancelled out. In this way, optical signal modulation method 300 modulates (i.e., turns on and off) an input CW light beam.

While a particular optical signal modulation method 300 has been described, it should be noted that certain steps may be rearranged, modified, or eliminated where appropriate. Additionally, while certain embodiments have been described in detail, numerous changes, substitutions, variations, alterations and modifications may be ascertained by those skilled in the art, and it is intended that the present disclosure encompass all such changes, substitutions, variations, alterations and modifications as falling within the spirit and scope of the appended claims.

1. An optical modulator comprising:
an input waveguide;
a splitting point operable to split an incoming continuous wave light beam received via the input waveguide into a first light beam and a second light beam, the incoming continuous wave light beam comprising a first wavelength of light and a second wavelength of light;
a first interaction arm coupled to the input waveguide at the splitting point, the first interaction arm having a first length L₁ and operable to transmit the first light beam;
a second interaction arm coupled to the input waveguide at the splitting point, the second interaction arm having a second length L₂ unequal in length to the first interaction arm and operable to transmit the second light beam; and
an output waveguide coupled to the first interaction arm and the second interaction arm at a recombination point such that the first light beam and second light beam are combined into an output modulated light beam,
wherein the first interaction arm and the second interaction arm comprise an electro-optic material with a refractive index that changes according to a modulation stimulus, the electro-optic material having a first refractive index n₁ before the modulation stimulus is applied, and a second refractive index n₂ after the modulation stimulus is applied, the first length L₁ and the second length L₂ comprising lengths such that the output modulated light beam does not comprise the first wavelength of light and the second wavelength of light when the modulation stimulus is applied, and comprises the first wavelength of light and the second wavelength of light when the modulation stimulus is not applied, the first wavelength of light and the second wavelength of light being substantially unattenuated when the stimulus is not applied.

2. The optical modulator of claim 1 further comprising a stimulus source operable to apply the modulation stimulus to the first interaction arm and the second interaction arm, the modulation stimulus operable to cause a change in refractive index Δn according to the equation:
Δn=n₂−n₁

3. The optical modulator of claim 1 wherein the modulation stimulus comprises a voltage bias operable to produce a phase difference Δφ between the first light beam and the second light beam according to the equation:
$$Δφ = 2 π \frac{{L}_{2} Δ n + {n}_{1} Δ L}{λ}$$
where λ is a wavelength of light present in the incoming continuous wave light beam, Δn is the difference between n₁ and n₂ according to the equation:
Δn=n₂−n₁
and ΔL is the difference between L₁ and L₂ according to the equation:
ΔL=L₁−L₂

4. The optical modulator of claim 1 wherein the difference ΔL between L₁ and L₂ is found according to the equation:
$$Δ L = \frac{1}{{n}_{1}} ( \frac{Δ m}{\frac{1}{{λ}_{a}} - \frac{1}{{λ}_{b}}} + \frac{{λ}_{a}}{2} )$$
where λₐ is a first wavelength of light present in the incoming continuous wave light beam, λ_{b} is a second wavelength of light present in the incoming continuous wave light beam, and Δm is the difference between an integer mₐ and an integer m_{b} according to the equation:
Δm=mₐ−m_{b}

5. A method of modulating an optical signal comprising:
receiving an incoming continuous wave light beam with an input waveguide, the incoming continuous wave light beam comprising a first wavelength of light and a second wavelength of light;
splitting the incoming continuous wave light beam into a first light beam and a second light beam at a splitting point;
transmitting the first light beam in a first interaction arm coupled to the input waveguide at the splitting point, the first interaction arm having a first length L₁;
transmitting the second light beam in a second interaction arm coupled to the input waveguide at the splitting point, the second interaction arm having a second length L₂ unequal in length to the first interaction arm;
combining the first light beam and the second light beam into an output modulated light beam at a recombination point; and
transmitting the output modulated light beam away from the recombination point in an output waveguide, the output waveguide coupled to the first interaction arm and the second interaction arm at the recombination point,
wherein the first interaction arm and the second interaction arm comprise an electro-optic material with a refractive index that changes according to a modulation stimulus, the electro-optic material having a first refractive index n₁before the modulation stimulus is applied, and a second refractive index n₂ after the modulation stimulus is applied, the first length L₁ and the second length L₂ comprising lengths such that the output modulated light beam does not comprise the first wavelength of light and the second wavelength of light when the modulation stimulus is applied, and comprises the first wavelength of light and the second wavelength of light when the modulation stimulus is not applied, the first wavelength of light and the second wavelength of light being substantially unattenuated when the stimulus is not applied.

6. The method of modulating an optical signal of claim 5 further comprising providing a stimulus source operable to apply the modulation stimulus to the first interaction arm and the second interaction arm, the modulation stimulus operable to cause a change in refractive index Δn according to the equation:
Δn=n₂−n₁

7. The method of modulating an optical signal of claim 5 wherein the modulation stimulus comprises a voltage bias operable to produce a phase difference Δφ between the first light beam and the second light beam according to the equation:
$$Δφ = 2 π \frac{{L}_{2} Δ n + {n}_{1} Δ L}{λ}$$
where λ is a wavelength of light present in the incoming continuous wave light beam, Δn is the difference between n₁ and n₂ according to the equation:
Δn=n₂−n₁
and ΔL is the difference between L₁ and L₂ according to the equation:
ΔL=L₁−L₂

8. The method of modulating an optical signal of claim 5 wherein the difference ΔL between L₁ and L₂ is found according to the equation:
$$Δ L = \frac{1}{{n}_{1}} ( \frac{Δ m}{\frac{1}{{λ}_{a}} - \frac{1}{{λ}_{b}}} + \frac{{λ}_{a}}{2} )$$
where λₐ is a first wavelength of light present in the incoming continuous wave light beam, λ_{b} is a second wavelength of light present in the incoming continuous wave light beam, and Δm is the difference between a first integer mₐ and a second integer m_{b} according to the equation:
Δm=mₐ−m_{b}
